(19) United States
(12) Patent Application Publication
(10) Pub. No.: US 2006/0073461 A1
(43) Pub. Date: Apr. 6, 2006

(54) Method and system for estimating educational resources

(76) Inventors: Thomas R. Gillaspy, Raleigh, NC (US); Melody K. Henderson, Durham, NC (US); Dru J. Herman, Wappingers Falls, NY (US); Rosemarie Livigni, Louisville, CO (US); Brent E. Sargent, Duxbury, VT (US)

Correspondence Address: Silvy Anna Murphy, Esq., 100 Turnberry Lane, Cary, NC, 27511, US

(21) Appl. No.: 10/947,417

(22) Filed: Sep. 22, 2004

(51) Int. Cl. G09B 7/00

(52) U.S. Cl. 434/322

(57) ABSTRACT

A method for managing educational resources needed to deliver classroom education. The method comprises providing a computer model with a set of predetermined educational delivery data, entering into the computer model a plurality of educational delivery data which includes measured educational delivery data that is accumulated over a time period and historically measured educational delivery data that is accumulated over several time periods, and calculating with the provided set of predetermined educational delivery data and the entered educational delivery data the educational resources needed to deliver education. The method further includes adjusting one or more of the provided set of predetermined educational delivery data and the entered educational delivery data so as to forecast one or more of the educational resources needed to deliver education.

### FIELD OF THE INVENTION

The present invention relates to a method for managing and/or estimating educational resources needed to deliver education.

### BACKGROUND OF THE INVENTION

Organizations/corporations have been providing education to its employees both onsite and offsite. The movement to virtual delivery is changing the delivery landscape and is affecting business managers at these organizations/corporations providing educational and learning delivery. This changing delivery landscape provides an opportunity for educational providers to redesign or re-engineer their existing educational facilities so that these facilities can be managed more effectively and efficiently. Furthermore, economically, it has become imperative that organizations/corporations examine their efficiency as far as resources are concerned in planning and operating such educational facilities.

### SUMMARY OF THE INVENTION

In a first aspect of the invention, there is provided a method for managing a plurality of educational resources needed to deliver classroom education. The method comprises providing a computer model with a set of predetermined educational delivery data, entering into the computer model a plurality of educational delivery data, the plurality of educational delivery data includes a plurality of measured educational delivery data that is accumulated over a time period and a plurality of historically measured educational delivery data that is accumulated over a plurality of time periods, and calculating with the provided set of predetermined educational delivery data and the entered plurality of educational delivery data the plurality of educational resources needed to deliver education. The method further includes adjusting one or more of the provided set of predetermined educational delivery data and the entered plurality of educational delivery data so as to forecast one or more of the plurality of educational resources needed to deliver education. The step of providing a computer model further comprises providing separate delivery location models for each one of a set of educational venues and providing a rollup model for incorporating the separate delivery location models for one or more of the set of educational venues and calculating the plurality of educational resources needed to deliver education at the one or more of the set of educational venues. Furthermore, the method comprises loading the separate delivery location models for a subset of the set of educational venues, and selecting from the separate delivery location models loaded for the subset of the educational venues particular educational venues to be included in the rollup model so as to evaluate the plurality of educational resources needed to deliver education at the particular educational venues.

In another embodiment of the invention, there is provided a method for estimating and/or predicting one or more of a plurality of educational delivery resources needed to deliver education to at least one educational venue. The method comprises providing a plurality of measured educational delivery data, the plurality of measured educational delivery data including actual measured educational delivery data and estimated measured educational delivery data, and providing a plurality of historically measured educational delivery data, the plurality of historically measured educational delivery data including actual historically measured educational delivery data and estimated historically measured educational delivery data, inputting the plurality of measured and historically measured educational delivery data into a delivery location model with a set of predetermined educational delivery data, and executing the delivery location model so as to calculate one or more of the plurality of educational delivery resources needed to deliver education to the at least one educational venue. The method further comprises analyzing the one or more of the plurality of educational delivery resources calculated by the delivery location model, and adjusting one or more of the inputted plurality of educational delivery data and the predetermined educational delivery data so as to validate the one or more of the plurality of educational delivery resources needed to deliver education at the at least one educational venue.

In yet another embodiment of the invention, there is provided a programmable media containing programmable software to manage educational delivery resources. The programmable software comprises the steps of accessing a set of predetermined educational delivery data, receiving in a memory a plurality of educational delivery data, and calculating from the set of predetermined educational delivery data and the plurality of educational delivery data an estimate of the educational delivery resources needed to deliver education. Further, the step of receiving in a memory further includes the steps of providing a plurality of measured educational delivery data accumulated over a time period and providing a plurality of historically measured educational delivery data accumulated over a plurality of time periods. The programmable software calculates the estimate of the educational delivery resources needed to deliver education with an accuracy of at least eighty-five percent. The programmable software further comprises the steps of receiving in the memory a second plurality of educational delivery data, and calculating from the set of predetermined educational delivery data and the second plurality of educational delivery data a second estimate of educational resources needed to deliver education.

Preferably, the plurality of educational resources is selected from the group consisting of: educational employee headcount, number of classrooms, classroom capacity, classroom utilization, enrollments per class or predictive number of student days. The set of predetermined educational delivery data includes classroom capacity, classes per educational employee per year, educational employee hours needed per class, educational employee hours available per year, enrollments per class, classroom utilization and number of available classdays per classroom per year. The plurality of measured educational delivery data includes number of classrooms, number of classroom seats, classroom utilization average, number of classes, number of student days, total number of students and offsite class percentage. Preferably, the measured educational delivery data further includes existing educational employee headcount and site population. Moreover, the time period for the plurality of measured educational delivery data is preferably a quarter and the plurality of time periods for the plurality of historically measured educational delivery data is preferably at least three preceding quarters, and more preferably, at least five preceding quarters. The plurality of historically measured educational delivery data includes classroom utilization average, number of classes, number of student days and total number of students.

### BRIEF DESCRIPTION OF THE DRAWINGS

The accompanying drawings which are incorporated in and form a part of this specification, illustrate embodiments of the invention and, together with the description, serve to explain the principles of the invention:

FIG. 1 is a flowchart demonstrating the various educational delivery inputs required by a software tool to implement a method of calculating the educational delivery resources needed to deliver education, in accordance with an embodiment of the present invention.

FIG. 2 is a flowchart illustrating the relationship between the Rollup Model and the Delivery Location Model, in accordance with an embodiment of the present invention.

FIG. 3 is a flowchart demonstrating a method for managing the plurality of educational resources needed to deliver education, which method is performed using a Delivery Location Model for one or more of a plurality of educational venues and a Rollup Model, in accordance with one embodiment of the invention.

FIG. 4 is a flowchart demonstrating a method for estimating one or more of the educational resources needed to deliver education at an educational venue or for starting a new educational venue, which method is performed using a Delivery Location Model, in accordance with one embodiment of the invention.

FIG. 5 is a flowchart demonstrating the plurality of headcount data inputted into the Headcount segment of a Delivery Location Model for calculating the total FTE Tactical and Strategic percentages, in accordance with an embodiment of the invention.

FIG. 6 shows an example of a Headcount segment of a Delivery Location Model, in accordance with an embodiment of the invention.

FIG. 7A shows an example of an Input section of a Work segment of a Delivery Location Model, in accordance with an embodiment of the invention.

FIG. 7B shows formulas for the Work segment of the Delivery Location Model of FIG. 7A, in accordance with an embodiment of the invention.

FIG. 8 shows an example of a Historical Data Input section of a Work segment of a Delivery Location Model, in accordance with an embodiment of the invention.

FIG. 9A shows an example of a Results section of a Work segment of a Delivery Location Model, in accordance with an embodiment of the invention.

FIG. 9B shows formulas for the Work segment of the Delivery Location Model of FIG. 9A, in accordance with an embodiment of the invention.

FIG. 10A shows an example of a Calculations section of a Work segment of a Delivery Location Model, in accordance with an embodiment of the invention.

FIG. 10B shows formulas for the Work segment of the Delivery Location Model of FIG. 10A, in accordance with an embodiment of the invention.

FIG. 11 shows an example of a Results section of a Summary segment of a Delivery Location Model, in accordance with an embodiment of the invention.

FIG. 12A shows an example of a Constants section of a Summary segment of a Delivery Location Model, in accordance with an embodiment of the invention.

FIG. 12B shows formulas for the Summary segment of the Delivery Location Model of FIG. 12A, in accordance with an embodiment of the invention.

FIG. 13 shows an example of an Input section of a Summary segment of a Delivery Location Model, in accordance with an embodiment of the invention.

FIGS. 14A, 14B, 14C & 14D show graphic portions of a Charts segment of a Delivery Location Model, in accordance with an embodiment of the invention.

FIGS. 15-16 show table portions of a Charts segment of a Delivery Location Model, in accordance with an embodiment of the invention.

FIGS. 17-18 show sections of the Summary segment of a Rollup Model, in accordance with an embodiment of the invention.

### BEST MODE FOR CARRYING OUT THE INVENTION

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

In one embodiment, the present invention provides a method for managing a plurality of educational resources needed to deliver classroom education. In particular, the invention provides a computer model or template that can be used by a business manager/ planner/user and/or a person employed in the educational business for managing a plurality of educational delivery resources or educational resources needed to deliver/provide classroom based education at one or more educational venues or facilities.

As used herein, the term “managing” is intended to comprise a multitude of tasks, such as, evaluating, analyzing, assessing, comparing, estimating, calculating, measuring, quantifying, scrutinizing, examining and studying a plurality of educational resources calculated by the computer model. In particular, the calculated educational resources are derived from a plurality of measured (versus estimated) educational delivery data that is entered into the model. Further, as used herein, the term “educational resources” or “educational delivery resources” include educational employee headcount (HC) or FTEs (Full-Time Equivalents, wherein an FTE is defined as one person working full time for forty hours per week per year), number of classrooms, classroom (CR) capacity, classroom (CR) utilization, enrollments per class and predictive number of student days.

The computer model is made up of a series of calculations and statistical approaches to quantify the plurality of educational resources needed to deliver classroom education. The model comprises a number of segments or forms, each of which relates to a specific area, but all of which are connected and integrated, so that these segments may together calculate and/or estimate the educational resources needed to deliver education based on the required input data.

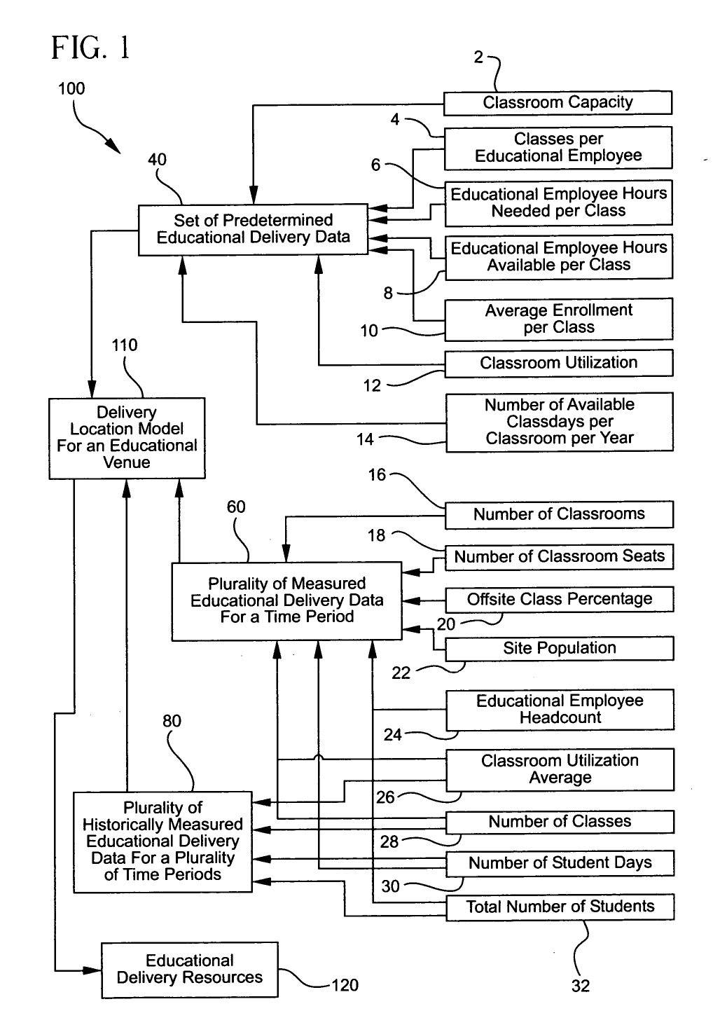

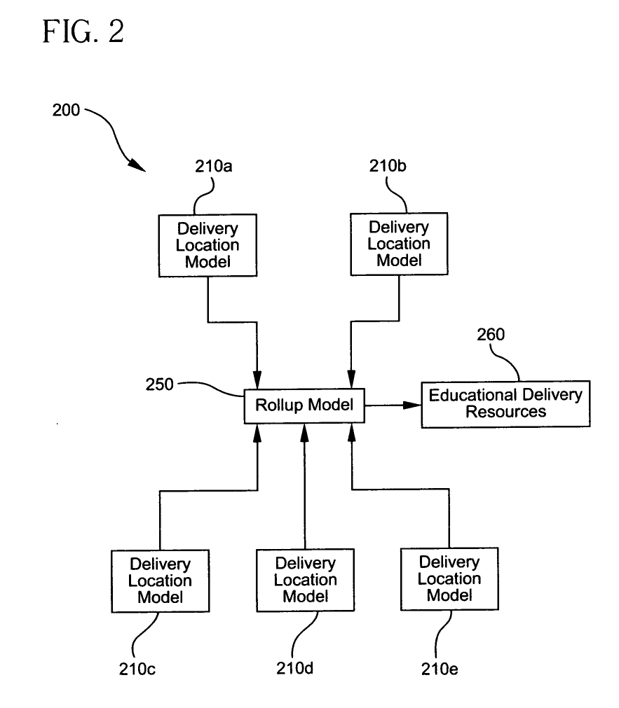

Referring to FIG. 1, numeral 100, depicts the process used to manage and/or evaluate the educational resources at a single educational venue or facility. When managing and/or evaluating the educational resources at a single educational venue or facility, the model comprises a Delivery Location Model (DLM) 110 that contains/provides a set of predetermined educational delivery data 40, also, referred to as model constants. Further, the Delivery Location Model 110 requires input of a plurality of educational delivery data that includes a plurality of measured educational delivery data 60 that is accumulated over a time period and a plurality of historically measured educational delivery data 80 that is accumulated over a plurality of time periods. Based on all the provided set of predetermined educational delivery data and on the measured and historically measured educational delivery data inputted into the model, the Delivery Location Model 110 calculates the plurality of educational delivery resources 120 needed to deliver education. However, when managing and/or evaluating the educational resources at multiple educational venues, as shown in FIG. 2, the model comprises a Delivery Location Model for each of the educational venues, numerals 210a- 210e, as well as a Rollup Model (RM) 250, wherein each of the Delivery Location Models 210a-210e and the Rollup Model 250 contain a given set of predetermined educational delivery data. As shown in FIG. 2, numeral 200, depicts the relationship between the Rollup Model 250 and each of the Delivery Location Models 210a-210e. The Rollup Model 250 is designed to incorporate one or more of the Delivery Location Models 210a-210e that have been created for each of the educational venues or facilities in question. Again, as described in FIG. 1, each of the Delivery Location Models require input of a plurality of measured and historically measured educational delivery data for the respective educational venues or facilities. The Rollup Model 250 uses the data in each of the Delivery Location Models 210a-210e to calculate the educational delivery resources 260 needed at the corresponding educational venues.

As described in FIG. 1, the set of predetermined educational delivery data 40 includes classroom capacity 2, classes per FTE or educational employee per year 4, educational employee or FTE hours needed per class 6, educational employee or FTE hours available per year 8, enrollments per class 10, classroom (CR) utilization 12 and number of available classdays per classroom per year 14. Most of these predetermined educational delivery data or model constants 40 are derived from years and years of experience delivering classroom based education at one or more educational venues. However, these model constants are a good starting point for even starting a new facility, and can be used when planning on establishing a new educational facility.

Moreover, as shown in FIG. 1, the plurality of measured educational delivery data 60 includes number of classrooms 16, number of classroom seats 18, classroom utilization average 26, number of classes 28, number of student days 30, total number of students 32 and offsite class percentage 20, that is, the percentage of classes held elsewhere. Preferably, the plurality of measured educational delivery data 60 further includes existing educational employee headcount 24, that is, full time equivalents (FTEs) and site population 22, which is the total number of employees at that one educational venue or facility that can enroll in classroom based education at that given educational venue. Further, the plurality of historically measured educational delivery data 80 includes classroom utilization average 26, number of classes 28, number of student days 30 and total number of students 32. In particular, the measured educational delivery data 60 is accumulated for the current quarter, whereas, the historically measured educational delivery data 80 is accumulated for at least three preceding quarters and preferably, for at least five preceding quarters.

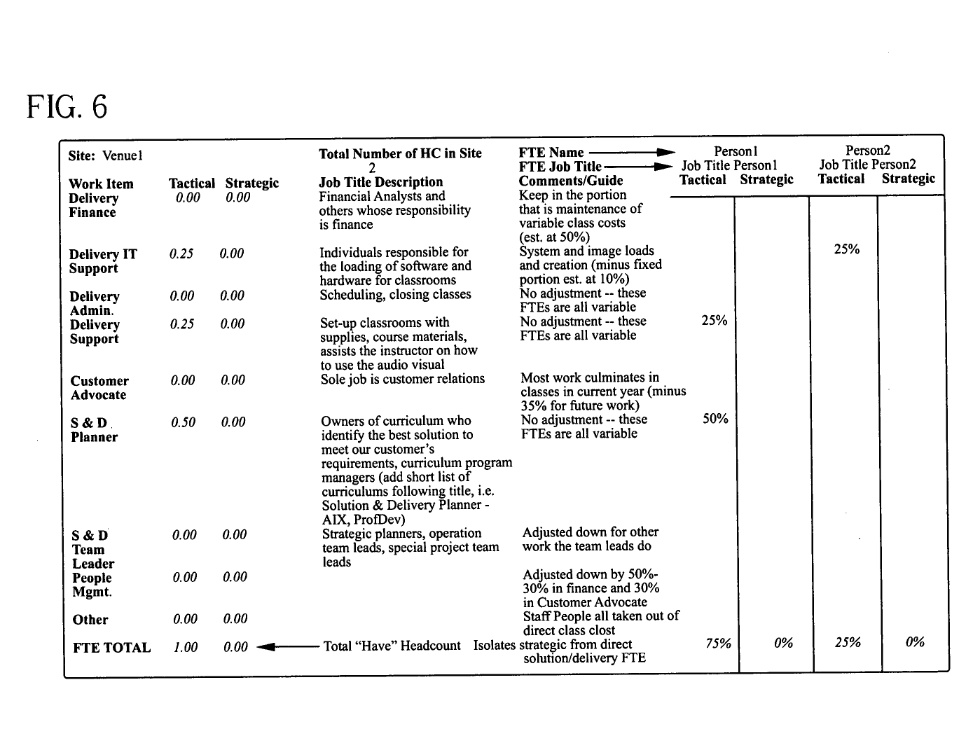

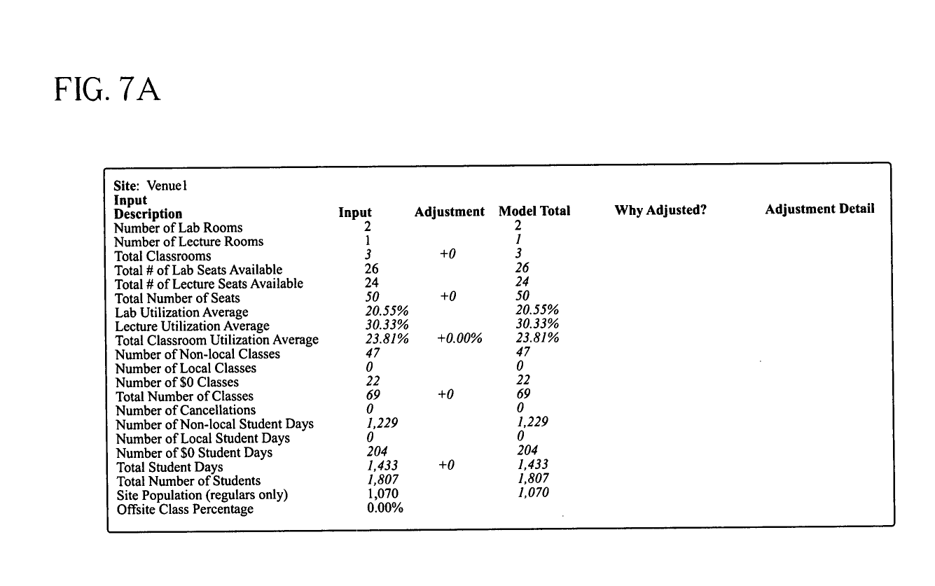

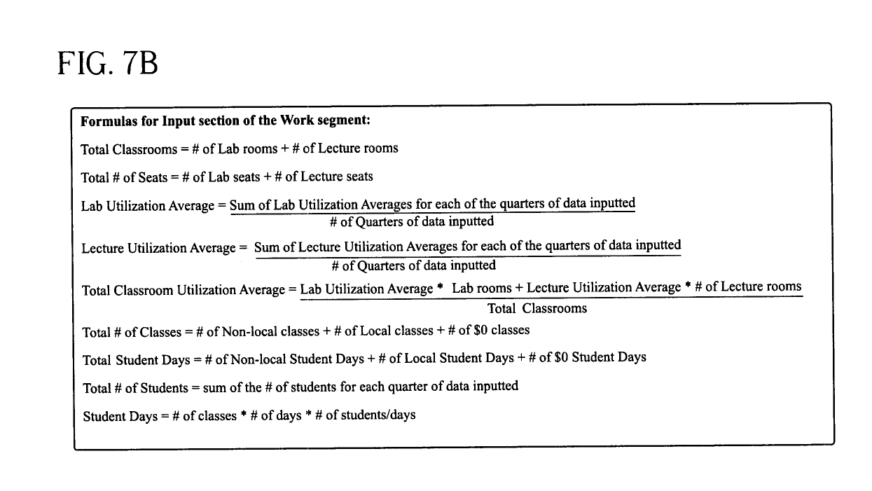

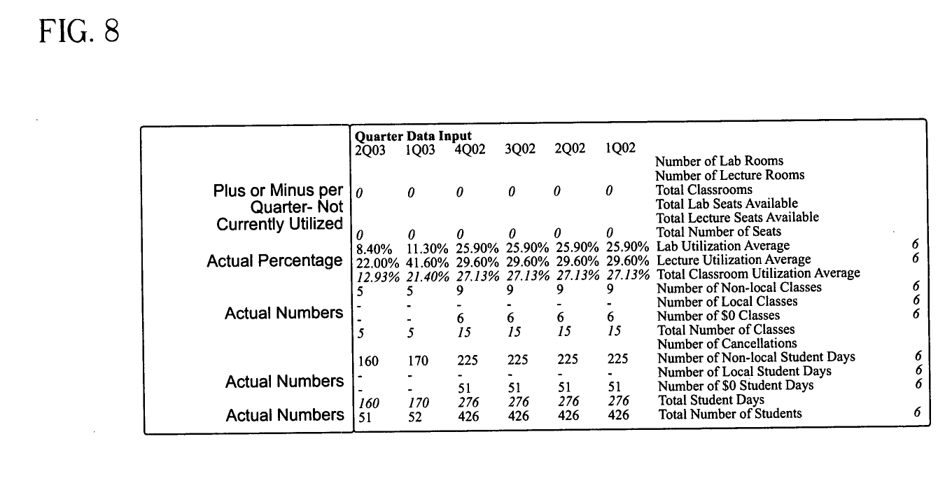

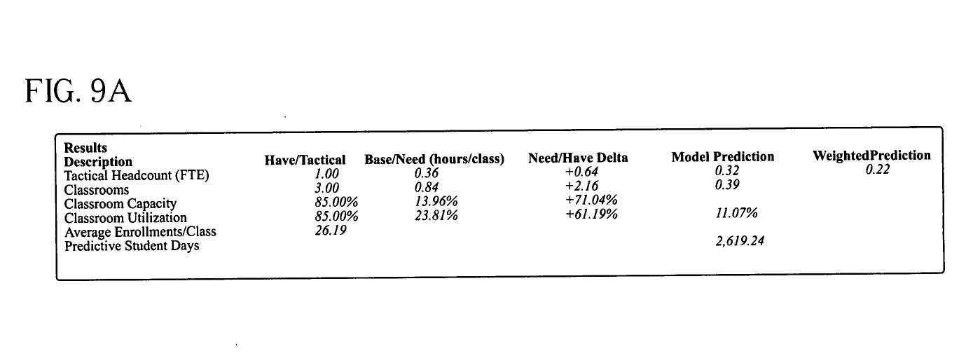

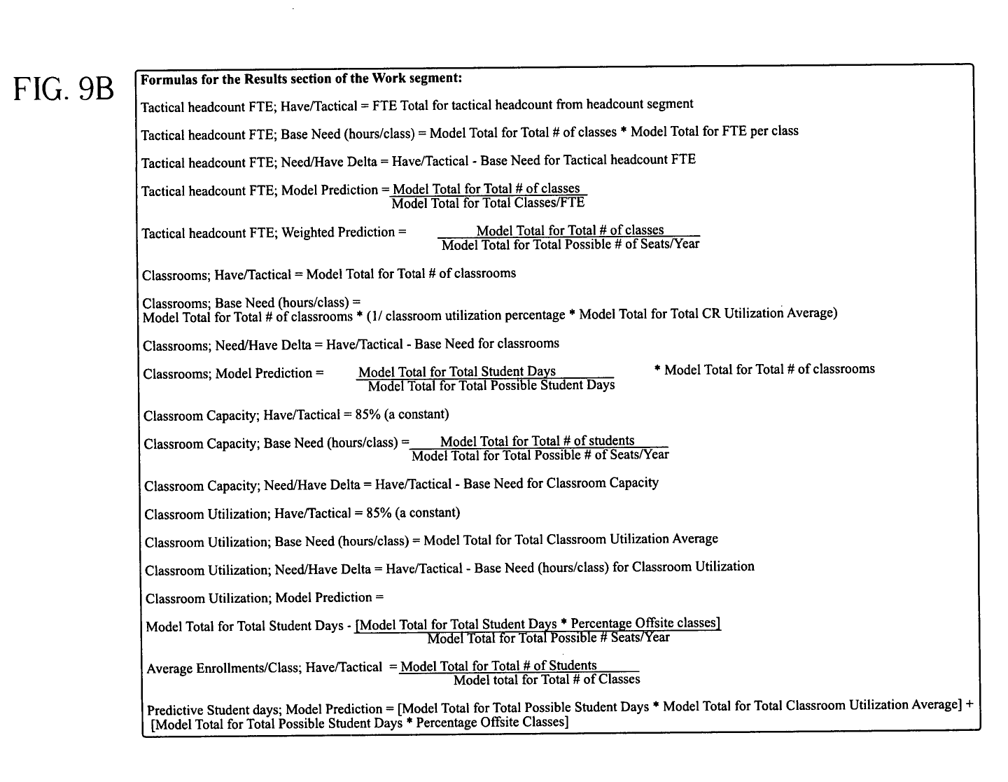

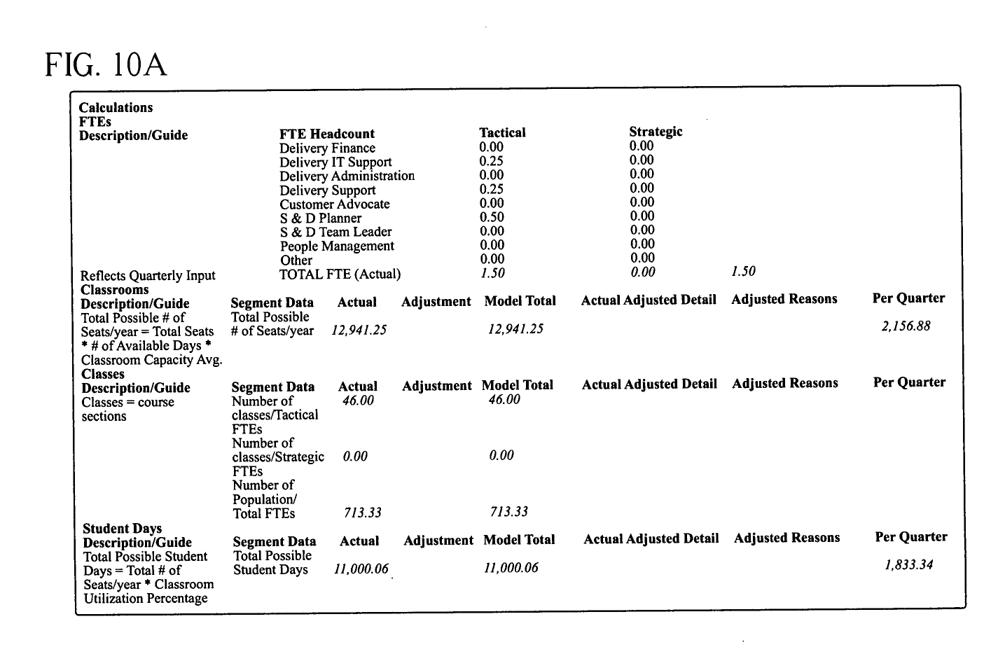

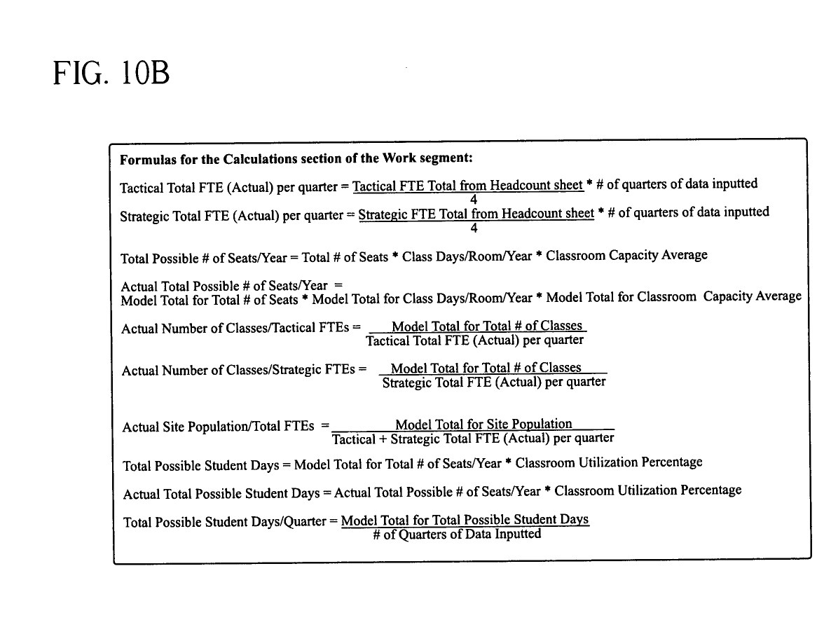

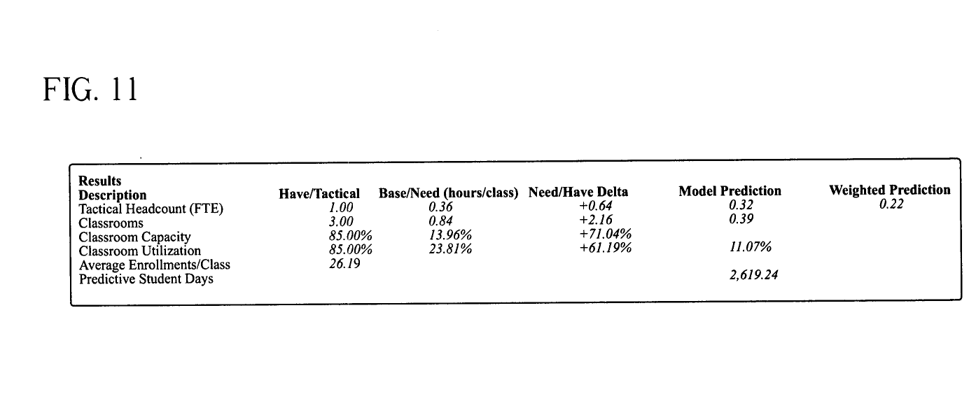

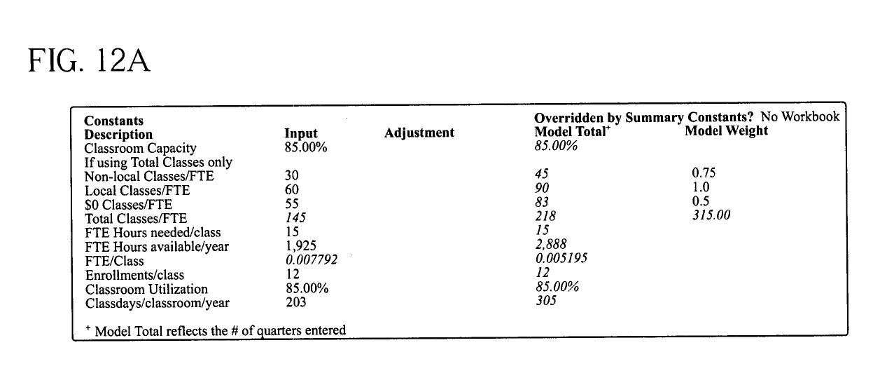

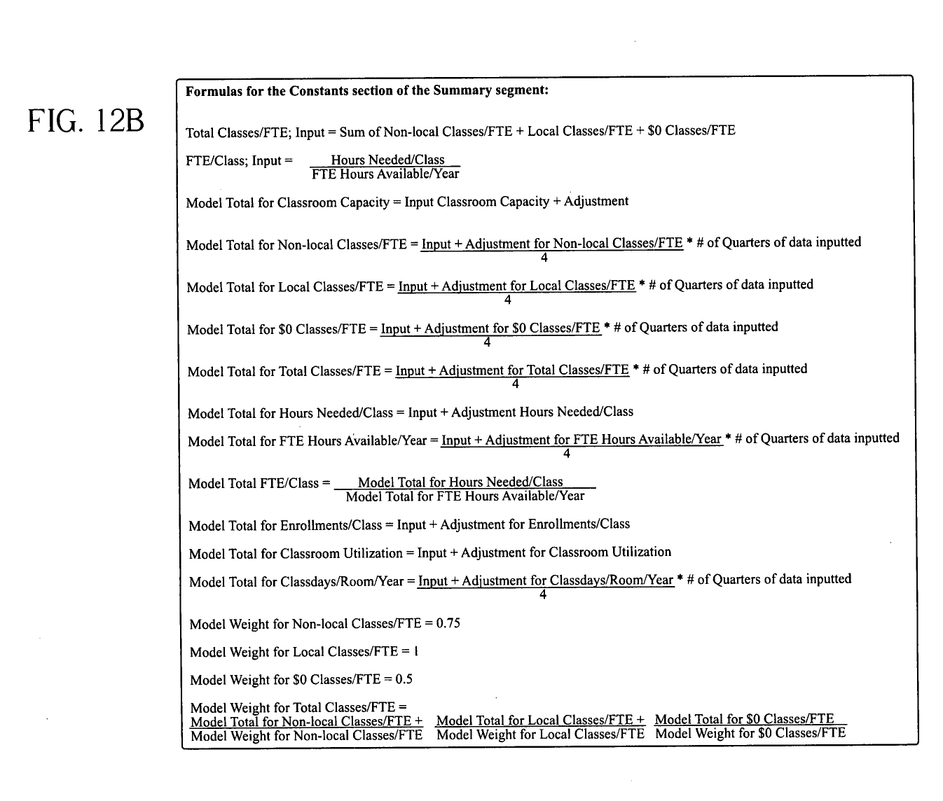

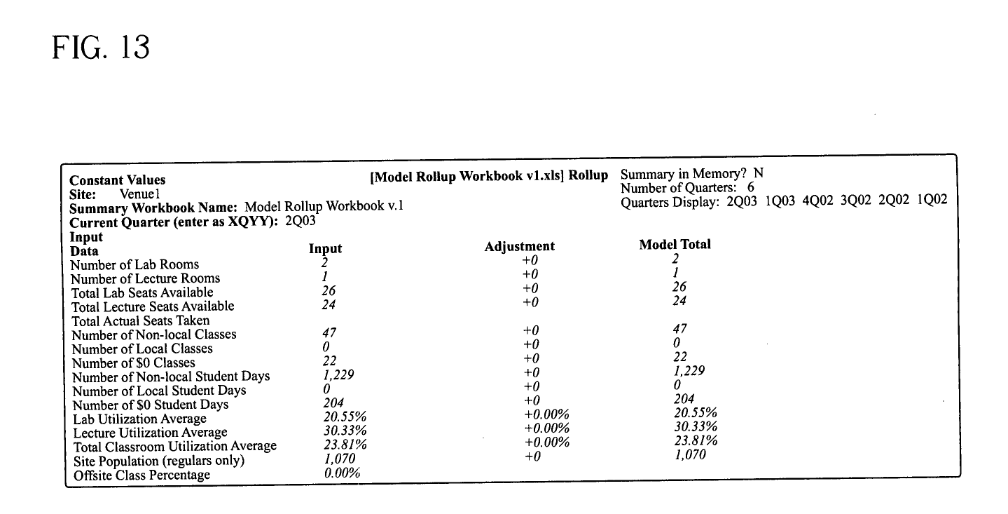

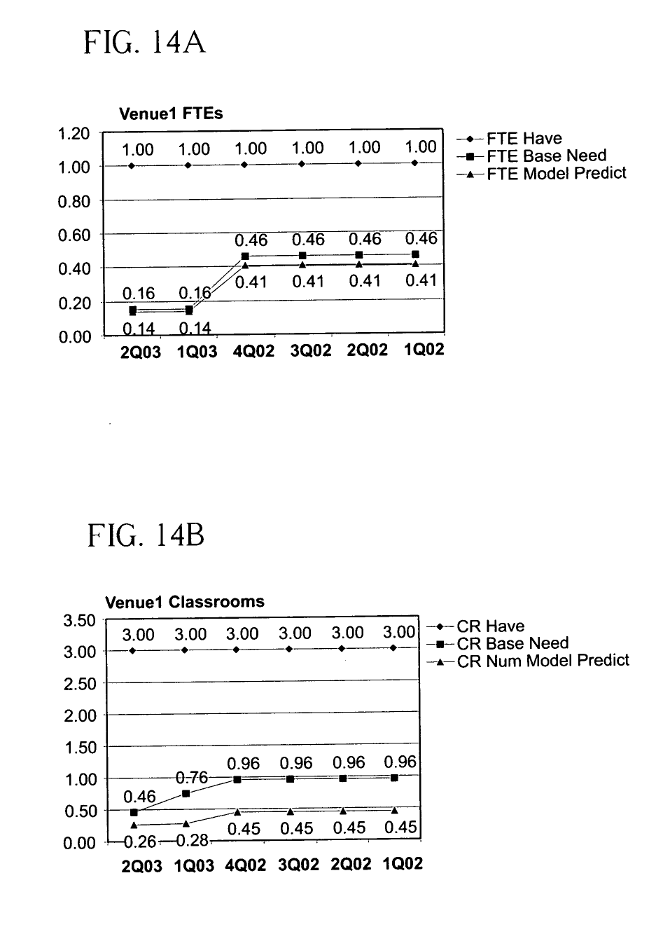

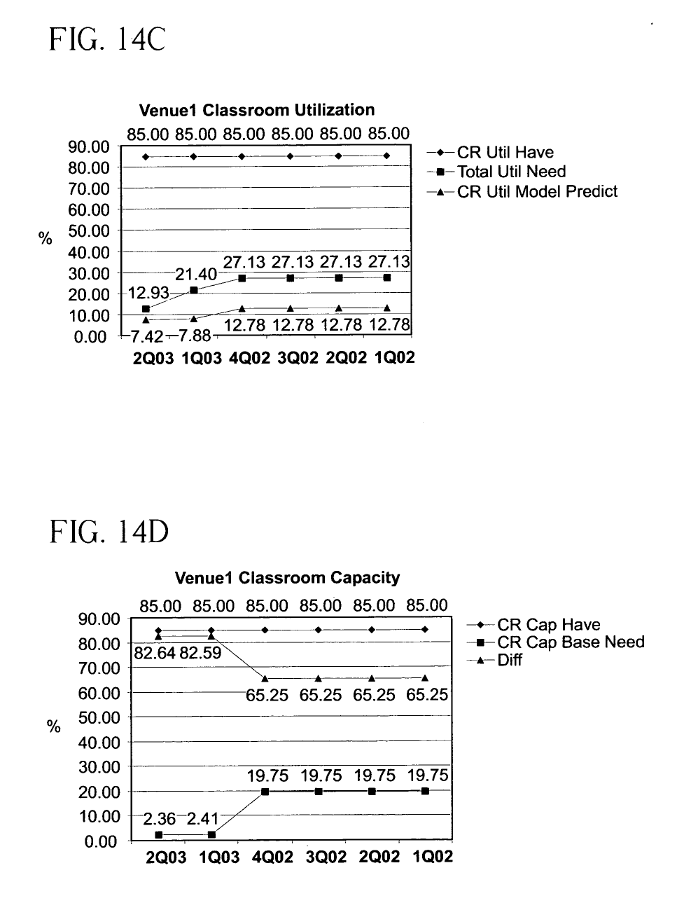

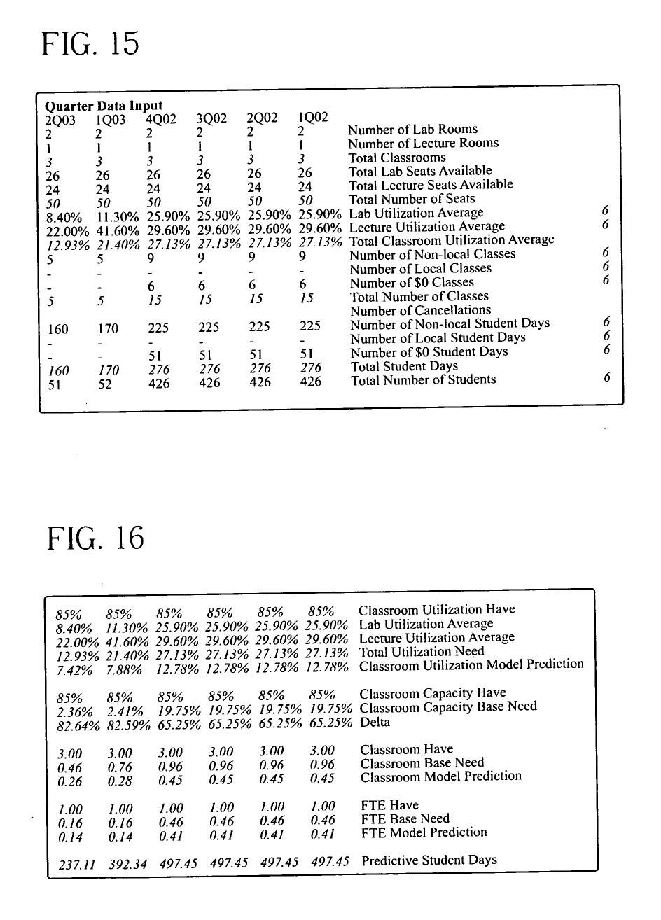

In a preferred embodiment, the Delivery Location Model comprises a Work Segment, a Summary Segment and a Charts Segment. However, more preferably, the Delivery Location Model comprises a Work Segment (FIGS. 7A, 8, 9A & 10A), a Summary Segment (FIGS. 11, 12A & 13), a Charts Segment (FIGS. 14A-14D, FIGS. 15-16), plus, a Headcount Segment (FIG. 6). Moreover, the Work Segment is further divided into an Input Section (FIGS. 7A and 8), a Results Section (FIG. 9A), and a Calculations Section (FIG. 10A). Similarly, the Summary Segment is further divided into a Results Section (FIG. 11), a Constants Section (FIG. 12A) and an Inputted Data Section (FIG. 13). Finally, the Charts Segment is divided into a Graphs section (FIGS. 14A-14D) and a table section (FIGS. 15 and 16), showing inputted and calculated data. Further, the Delivery Location Model can comprise additional segments (not shown herein) for explanations, instructions, as well as any assumptions used in the Delivery Location Model.

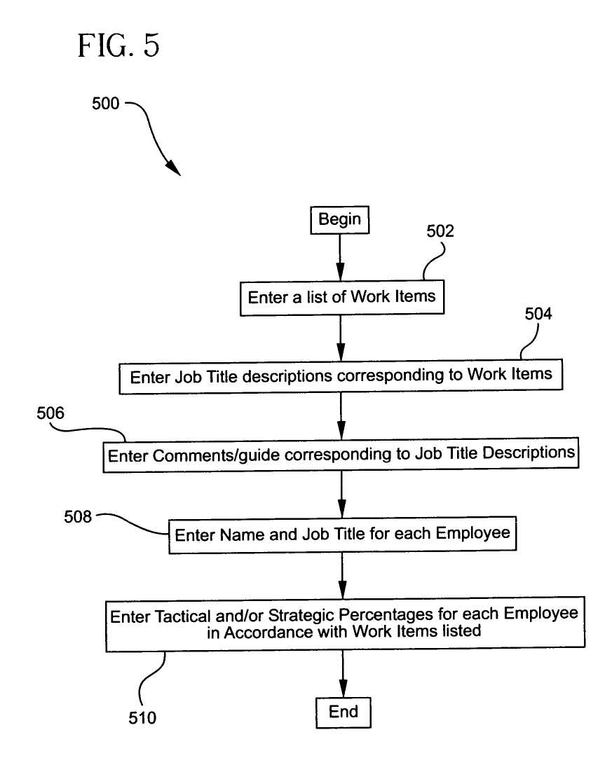

When using the Delivery Location Model for the first time, a manager/user can choose to “set up” the Headcount segment of the Delivery Location Model, as outlined in FIG. 5. Basically, numeral 500, refers to the process of setting up the Headcount segment of the Delivery Location Model. First, in step 502, the manager/user has to enter a list of job categories under “Work Item” for that educational venue. Further, in step 504, the manager has to enter a “Job Title Description” corresponding to the “Work Item”. Additionally, in step 506, the manager enters into a “Comments/Guide” section information that would be helpful in determining the “Tactical” and “Strategic” percentages to assign an individual listed in the Headcount segment. Once the Headcount segment has been set up in this manner, then the entered information can be saved as part of the Delivery Location Model template, such that, from that point on, anyone wanting to use the Delivery Location Model can simply load up the template and enter the required headcount data, that is, enter the Name and Job Title fore each individual employee or FTE employed in the delivery of education at that educational venue, step 508 and enter Tactical and/or Strategic percentages for each of the employed individuals for the Work Items listed, step 510. Alternatively, in addition to setting up the Headcount segment, steps 502-506, the manager can also enter headcount data steps 508-510, so a user does not have to enter the headcount data every single time, but only when the headcount data changes. Based on the entered headcount data, for each of the Work Items, the Delivery Location Model calculates the FTE Total Tactical and Strategic percentages for all the employees listed, as shown in FIG. 6. As used herein, the term “Tactical” refers to work that has a relatively short-term or direct impact, whereas, the term “Strategic” refers to work that has a long-term or indirect impact, for instance, work that does not come to fruition until the following year.

Thus, in order to use the Delivery Location Model, a manager/user first loads up a Delivery Location Model template containing the given set of predetermined educational delivery data and, preferably, containing a “set up” Headcount segment as well. Then, the manager/user enters/inputs the name and job title for each of the employees or FTEs. Further, for each employee or FTE entered, the manager inputs a Tactical work percentage and a Strategic work percentage. As shown in the Headcount segment example of FIG. 6, the Tactical and Strategic percentages for each employee/FTE do not have to add up to 100%, especially, for example, when a person is employed only on a part-time basis or when a person spends time on stuff that is not listed in the Work Items category. The manager/user does not have to use the Headcount segment for the model to operate, however, given that the Tactical and Strategic percentages are transferred onto the Work segment and form the basis of some of the calculations performed by the model, the model provides a much more accurate estimation when the Tactical and Strategic percentages are provided for each of the employees involved in the delivery of education.

Then, the manager/user turns to the Input Section of the Work segment of the Delivery Location Model, shown in FIG. 7A. The manager/user inputs in the “Input” column a plurality of measured educational delivery data for a time period, preferably, a quarter. In particular, the inputted data as shown under the “Description” column includes number of lab rooms, number of lecture rooms, total number of lab seats available, total number of lecture seats available, site population and offsite class percentage. The model calculates the italicized data shown in FIG. 7A. Also, as shown in FIG. 8, the manager/user inputs under the “Quarter Data Input” column of the Work segment of the Delivery Location Model a plurality of historically measured educational delivery data for a plurality of time periods, preferably, at least three preceding quarters, more preferably, at least five preceding quarters, as shown for the quarters 2Q03, 1Q03, 4Q02, 3Q02, 2Q02 and 1Q02. Then, the Delivery Location Model is executed to calculate the educational delivery resources. The Delivery Location Model utilizes the given set of predetermined educational delivery data and the inputted measured educational delivery data and the inputted historically measured educational delivery data to calculate the educational resources needed to deliver education at that particular educational venue. The calculations (italicized data) are shown in the Work Segment, whereas, the Results are shown in the Work Segment, the Summary Segment as well as the Charts Segment of the Delivery Location Model.

Once the user has entered the plurality of measured educational delivery data and the historically measured educational delivery data and has created a Delivery Location Model for a particular educational venue, the user can save that version of the Delivery Location Model onto a suitable computer readable storage medium, for example, the hard drive of a computer or on a compact disc or a floppy, etc., so that the user can load the created Delivery Location Model in the future for further calculations and/or estimations of educational resources needed to deliver education. Accordingly, the Delivery Location Model can be used, for instance, to determine whether or not there are enough employees or the right combination of employees to deliver education or a desired level of efficiency. Additionally, a manager can assess classroom utilization and/or classroom capacity.

Furthermore, if there are one or more educational venues or facilities, the manager/user first needs to create or be provided with a separate/individual Delivery Location Model for each of the educational venues, as well as needs to create or be provided with a Rollup Model that also contains a set of predetermined educational delivery data, preferably, the same used for each of the separate Delivery Location Models. Then, the manager can utilize the Rollup Model, which is designed to incorporate one or more of the Delivery Location Models that have been created for each of the educational venues or facilities in question, as shown in FIG. 2. In effect, the manager/user can utilize the Rollup Model to evaluate/gauge the overall efficiency with respect to the plurality of educational resources employed at the various educational venues or facilities, and can validate and/or substantiate one or more of the educational resources needed to deliver classroom based education. Based on the calculated educational resources provided by the Rollup Model, a manager can evaluate or determine the efficiency levels with respect to one or more educational resources being used at educational facilities located either in a certain geographic region or the entire country, provided that Delivery Location Models have been created and stored for these educational facilities in question. Further, the manager can use the knowledge gained from the calculated educational resources to begin the process of replicating desired efficiency levels at one or more other educational facilities.

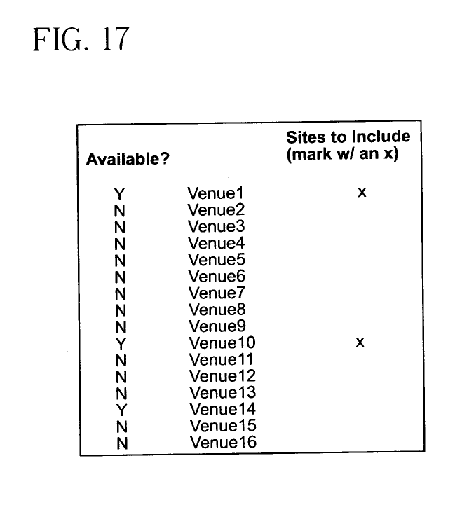

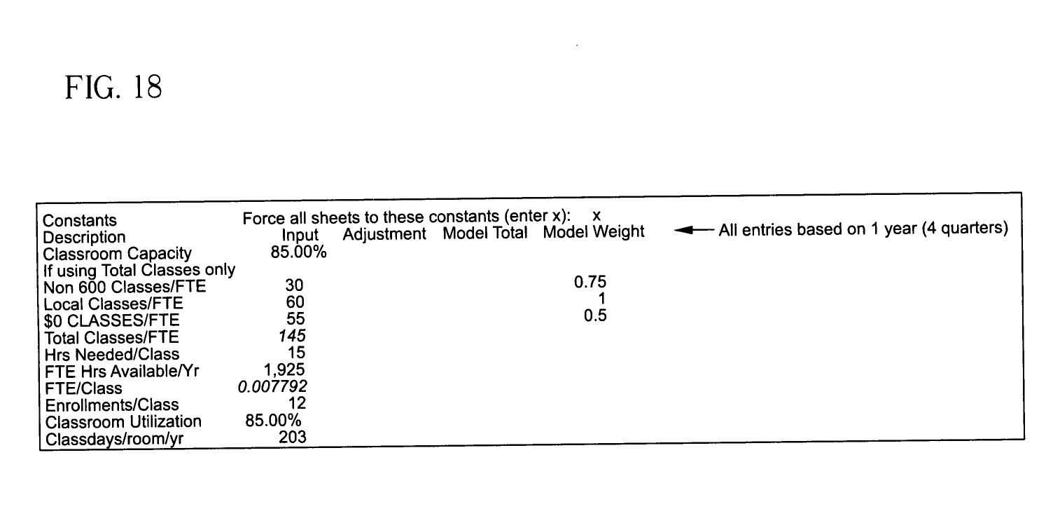

For instance, in order to evaluate a certain geographic region, the manager would have to first load the Delivery Location Models for each of the desired educational facilities in that region. Similarly, if interested in the entire country, the manager would load up all the Delivery Location Models created for educational venues or facilities throughout the entire country. Then, the manager loads up the Rollup Model, which is preferably made up of two segments, a Summary segment and a Charts segment. The Summary segment of the Rollup Model is similar to that of the Delivery Location Model, in that it includes a Results section, a Constants section and an Inputted Data section. However, the Rollup Model also includes a list or set of all of the Delivery Location Models throughout the country, as shown in FIG. 17, and has an “Available” column with a value of either a “N” or a “Y” placed next to the individual educational venues. If all of the Delivery Location Model have been loaded, then the entire set of educational venues will have a “Y” in the “Available” column, whereas, if only a certain number of the Delivery Location Models are loaded, then only those loaded will have a “Y” placed next to the venue on the Summary segment of the Rollup Model. Next, the manager/user selects from the set of the Delivery Location Models loaded by placing an “x” in the “Sites to Include (mark w/ an x)” column of the Summary segment of the Rollup Model. The manager can select all or only a subset of the Delivery Location Models loaded, in order for these selected educational venues to be included in the Rollup Model calculations. The term “subset” is being used here in a mathematical sense, wherein a subset of a set may include all the elements of the set, but does not have to. For example, as shown in FIG. 17, the Delivery Location Models for Venue1, Venue10 and Venue14 have been loaded as indicated by the “Y” in the “Available” column. Further, Venue1 and Venue10 have been selected to be used in the Rollup Model, as indicated by the “x” in the “Sites to Include (mark w/ an x” column. Also, as shown in FIG. 18, the “Constants” section of the Summary segment of the Rollup Model, gives a manager/user the choice of whether or not to use the constants or set of predetermined educational delivery data contained in the Rollup Model by entering an “x” next to the box containing the text “Force all sheets to these constants (enter x)”.

When using the model for estimating or predicting educational resources, the calculated educational resources serve only as a starting reference point for the manager/user of a particular educational venue, that is, the manager can adjust one or more of the provided data and/or the entered data. In particular, the manager/user can adjust data in any one or more of the following categories: the given set of predetermined educational delivery data or model constants, the entered measured educational delivery data, the entered historically measured educational delivery data, as well as a plurality of calculated data (when using the Delivery Location Model).

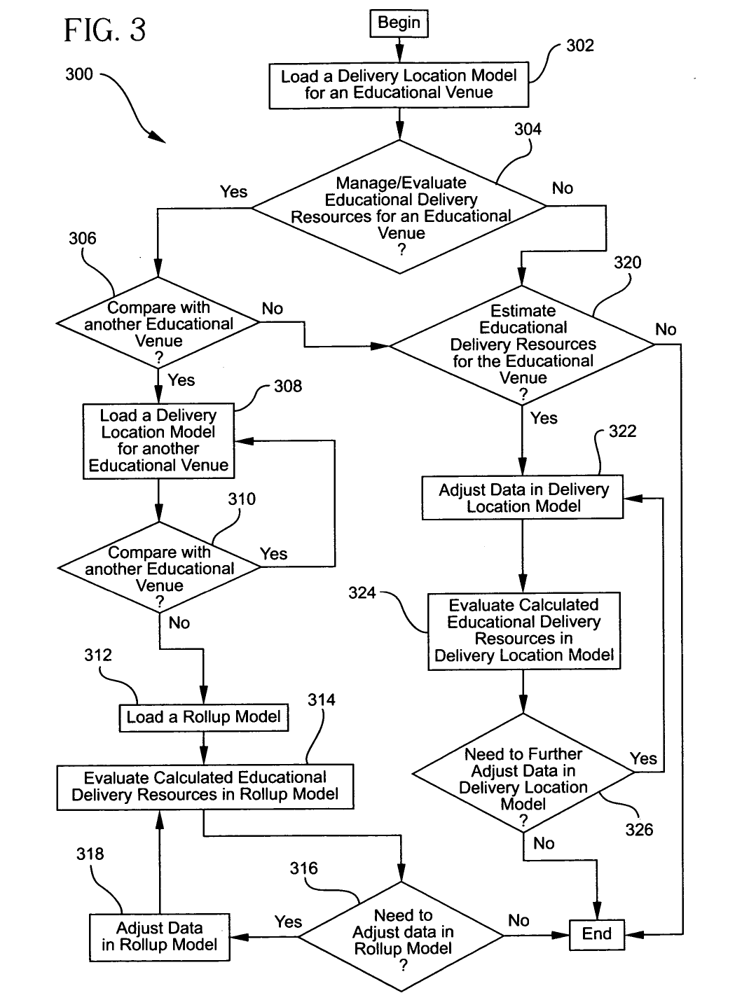

FIG. 3, numeral 300, illustrates the process of calculating educational resources when a Delivery Location Model has been created for one or more or all of the existing educational venues or facilities. A manager/user loads up a Delivery Location Model for the first educational venue, step 302. The manager can choose to either manage/evaluate the educational delivery resources for that first educational venue or can choose to estimate or predict the educational delivery resources for that first educational venue, step 304. If the manager chooses to manage/evaluate, the manager can further choose to compare the educational delivery resources for the first educational venue with that of another educational venue, step 306. In this case, the manager loads up a Delivery Location Model for a second educational venue, step 308. Furthermore, if the manager wants to evaluate the educational delivery resources utilized at yet another educational venue, step 310, then the manager can go back and load up a Delivery Location Model corresponding to that another educational venue or facility, step 308. When the manager has completed loading up the Delivery Location Models for the desired educational venues, the manager then loads up the Rollup Model, step 312. Based on the Delivery Location Models loaded, the Rollup Model calculates the educational delivery resources needed for the corresponding educational venues. The manager evaluates in step 314 the calculated educational delivery resources in the Rollup Model, and the manager can decide to adjust one or more of the data shown in the Summary segment of the Rollup Model, step 318. The Rollup Model recalculates the educational delivery resources for those educational venues or facilities. Again, upon evaluating the calculated educational delivery resources, the manager can further adjust one or more of the data shown in the Rollup Model until a desired result is achieved.

On the other hand, if in step 304 the manager chooses to estimate or predict the educational delivery resources for that first educational venue, step 320, the manager adjusts one or more of the data in the Delivery Location Model, step 322. In particular, the manager can adjust any one of the following data in the Delivery Location Model: the set of predetermined educational delivery data, the plurality of measured educational delivery data, as well as a plurality of calculated data. The plurality of calculated data includes total possible number of seats, number of classes/Tactical FTE and number of classes/Strategic FTE, number of population/Total FTE, and total possible student days. After adjusting the data, the Delivery Location Model recalculates the educational delivery resources, which are displayed on the Summary segment of the Delivery Location Model. Upon evaluating the recalculated educational delivery resources, step 324, the manager can further choose to adjust one or more of the data in the Delivery Location Model in step 326 and this process can be repeated to obtain further estimates or to achieve a desired result with respect to the calculated educational delivery resources.

In another embodiment, the invention provides a method for estimating and/or forecasting one or more of a plurality of educational delivery resources needed to deliver classroom based education at either an existing educational venue or for opening up a new educational venue. In particular, similar to the term “managing”, as used herein, the term “estimating” or “forecasting” is intended to comprise a multitude of tasks, such as, evaluating, analyzing, assessing, comparing, estimating, calculating, measuring, quantifying, scrutinizing, examining and studying a plurality of educational resources calculated by the computer model. However, the difference between managing and estimating/forecasting is that the calculated educational resources are derived from a plurality of measured and/or estimated educational delivery data that is entered into the model, for instance, when there is not enough accumulated measured and/or historical data or when starting a new educational facility.

When using the model to estimate and/or forecast one or more of a plurality of educational delivery resources for either an existing educational venue or for starting up a new educational venue, preferably, the manager first proceeds to enter into the Headcount segment a plurality of headcount data regarding each of the employees in the education delivery business, as per steps 508 and 510 in FIG. 5. However, as explained above, the manager/user does not have to use the Headcount segment for the Delivery Location Model to operate. Alternatively, the manager/user can skip using the Headcount segment and simply input an estimate for the total Tactical and Strategic percentages in the Work segment of the Delivery Location Model. However, in order to estimate the total Tactical and Strategic percentages, the manager/user would have to have some idea or estimate of how many employees are going to be employed in the delivery of education.

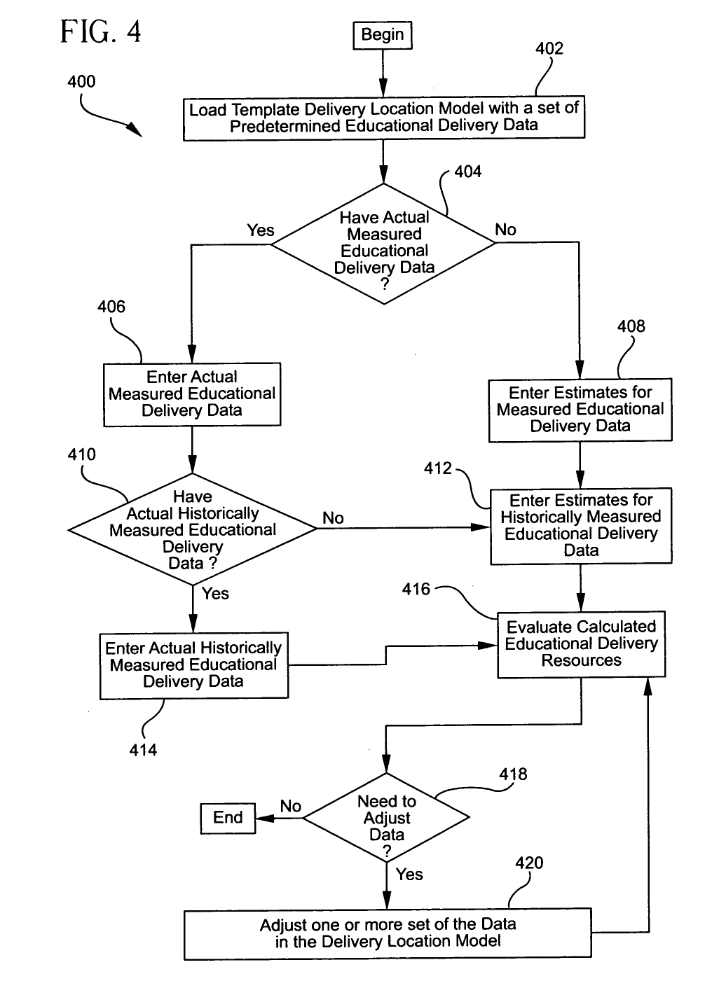

Referring to FIG. 4, numeral 400, depicts the method steps when using the model for estimating educational resources for either an existing educational venue (that is, when using the model for the first time) or for starting up a new educational venue. In both cases, as per step 402, the manager loads a template of the Delivery Location Model containing a set of predetermined educational delivery data and, if it is an existing educational venue, preferably, the template also contains a “set up” Headcount segment. If the Delivery Location Model is being used for an existing educational venue, and if there is actual measured educational delivery data as per step 404, that is, the educational venue has been tracking or accumulating measured educational delivery data for that educational venue for the time period that the manager is interested in, for instance, a quarter, then the manager enters/inputs in step 406 the required measured educational delivery data for that educational venue for the quarter in the Work segment of the Delivery Location Model. The actual measured educational delivery data comprises actual measured educational delivery data for the quarter as well as actual historically measured educational delivery data for the preceding three to five quarters. However, if the Delivery Location Model is being used to create or start up a new educational venue, then the manager enters/inputs estimated educational delivery data, that is, knowledgeable estimates for some of the actual measured educational delivery data needed for the quarter as per step 408. In particular, and preferably, the manager/user enters estimates based on general knowledge in the education business or even from knowledge gained from evaluating data from other educational venues. Preferably, the manager/user has some idea of at least two of the following three measured educational delivery data: educational employee headcount, number of classes and/or number of classrooms. In particular, if the manager can input a knowledgeable estimate for any two of these measured educational delivery data, then the model can be used to provide an estimate for the third data input. Similarly, in step 410, if the educational venue has been tracking or accumulating historically measured educational delivery data, that is, data that has been collected for preferably the preceding three quarters, or more preferably, data that has been collected for preferably the preceding five quarters, then the manager enters the actual historically measured educational delivery data for the preceding three to five quarters in step 414. If not, the manager enters knowledgeable estimates for historically measured educational delivery data for the preceding three to five quarters in step 412. In both the case of an existing facility or starting a new facility, when using the Delivery Location Model to forecast or estimate educational resources, in step 416, the manager/user evaluates the calculated educational delivery resources shown in the summary and/or Work segments of the model, and can choose to adjust any one or more of the data inputted and/or provided for in the Delivery Location Model in step 418. If the manager chooses to adjust data in step 420, the Delivery Location Model displays a second set of calculated educational delivery resources. Again, the manager evaluates the second set of calculated educational delivery resources and decides whether or not to make further adjustments to the data. If further adjustments are made, the Delivery Location Model recalculates and displays a third set of calculated educational delivery resources. Thus, steps 416-420 can be repeated as many times until a desirable estimate or forecast is obtained for one or more of the plurality of educational delivery resources needed to deliver education. In particular, the manager/user can adjust any one or more of the following categories: the given set of predetermined educational delivery data provided for in the Delivery Location Model, the actual measured educational delivery data inputted, the actual historically measured educational delivery data inputted, the estimated measured educational delivery data inputted, the estimated historically measured educational delivery data inputted and a plurality of calculated data. The plurality of calculated data includes total possible number of seats, number of classes/Tactical FTE and number of classes/Strategic FTE, number of population/Total FTE, and total possible student days. For instance, the manager/user can adjust numbers in the model to increase or decrease number of classes and/or number of classrooms and evaluate the calculated headcount in the results section of the summary or Work segments to see whether or not more employees are necessary when adding more classes and/or classrooms.

Furthermore, in another embodiment, the invention provides a system that comprises a computer terminal or an equivalent device, a computer readable storage media or programmable media containing programmable software to manage educational delivery resources needed to deliver classroom based education in a form that is executable by a computer system. The programmable software comprises the steps of accessing a set of predetermined educational delivery data, receiving in a memory a plurality of educational delivery data, and calculating from the set of predetermined educational delivery data and the plurality of educational delivery data an estimate of the educational delivery resources needed to deliver education. Further, the step of receiving in a memory further includes the steps of providing a plurality of measured educational delivery data accumulated over a time period and providing a plurality of historically measured educational delivery data accumulated over a plurality of time periods. The programmable software calculates the estimate of the educational delivery resources needed to deliver education with an accuracy of at least eighty-five percent. The programmable software further comprises the steps of receiving in the memory a second plurality of educational delivery data, and calculating from the set of predetermined educational delivery data and the second plurality of educational delivery data a second estimate of educational resources needed to deliver education.

Preferably, a manager uses a computer terminal or an equivalent device for inputting a plurality of educational delivery data, namely, measured educational delivery data and historically measured educational delivery data. The inputted data can be stored in a memory either internal to the computer terminal or external to the terminal. The inputted data, which forms the basis of a series of calculations, may be performed either on a computer terminal, for instance, by using a spreadsheet, on a server linked to an electronic network, or on a client PC linked to an electronic network. Preferably, the series of calculations are carried out by means of a commercially available spreadsheet program, preferably, the Microsoft EXCEL® spreadsheet program. The calculation results may be either displayed on a visual display such as a computer monitor screen, printed out or stored in a memory either internal to the terminal or on a disc for later use.

The results of an example of calculated educational delivery resources for an educational facility called Venue1 using and creating a Delivery Location Model are shown in FIGS. 6, 7A, 8, 9A, 10A, 11, 12A, 13, 14A-14D, 15-16. Below is a detailed description of how the results, namely, the educational resources needed to deliver education at Venue1 are arrived at. In the example, the Delivery Location Model includes the Headcount segment (shown in FIG. 6), and shows the name of the educational venue or “Site”, namely “Venue1”. Also, the Delivery Location Model template includes the “set up” Headcount segment showing the various categories under “Work Item”, the “Job Title Description” as well as any comments or suggestions in the “Comments/Guide” column, so that the manager/user can enter the other necessary headcount data, such as “FTE Name”, “FTE Job Title” and percentages under the “Tactical” and “Strategic” columns for each of the FTEs. In the example shown in FIG. 6, the job categories for “Work Item” are “Delivery Finance”, “Delivery IT (Information Technology) Support”, “Delivery Admin. (Administration)”, “Delivery Support”, “Customer Advocate”, “S & D (Solution & Delivery) Planner”, “S & D Team Leader, “People Mgmt. (Management)”, and “Other”. The Headcount segment also indicates the “Total Number of HC in Site”, that is, the total headcount (HC), namely “2”. Further, there are two FTEs listed for this segment next to “FTE Name”, namely, “Person1” and “Person2”. FIG. 6 also shows each respective “FTE Job Title” as “Job Title1” and “Job Title2”. Also, shown are the “Tactical” and “Strategic” percentages entered for each of the two individuals. In particular, there are no percentages entered for “Delivery Finance”, “Delivery Admin.”, “Customer Advocate”, “S & D Team Leader, “People Mgmt.”, and “Other” given that these individuals are not involved in these aspects of the education delivery business. On the other hand, FIG. 6 shows that Person 1 spends 25% of his/her time doing “Tactical” work under the “Work Item” described as “Delivery Support” and spends 50% of his/her time doing “Tactical” work under the “Work Item” described as “S & D Planner”, whereas, Person 2 spends 25% of his/her time doing “Tactical” work describes as “Delivery IT Support”. The Delivery Location Model automatically calculates the “FTE TOTAL” (shown italicized in the last row) by summing up the individual “Tactical” and “Strategic” percentages for each “Work Item” (across in the second and third columns) and then by adding all the individual “Tactical” and “Strategic” percentages (downward in the second and third columns, also italicized). In this example, the “FTE TOTAL” for the number of FTEs that do “Tactical” work is 1.00, whereas, the “FTE TOTAL” for the number of FTEs that do “Strategic” is 0.00. This states that at Venue1 there is one FTE that works on “Tactical” type of work (that is, 75% is done by Person1 and 25% is done by Person2) and that there is no one who works on “Strategic” type of work. The individual “Tactical” and “Strategic” percentages are transferred on to the “Calculations” section of the Work segment of the Delivery Location Model, as shown in FIG. 10A. Also, each of the “Work Item” descriptions is repeated under the column heading of “FTE Headcount” in FIG. 10A.

Referring to the Work segment of the Delivery Location Model, the Work segment is sub-divided into three sections: an Input section, a Results section and a Calculations section. In the example, the Input section is shown separately in FIGS. 7A and 8, the Results section is shown in FIG. 9A, whereas, the Calculations section is shown in FIG. 10A. Turning to FIGS. 7A and 8, FIG. 7A shows the Input section where measured educational delivery data for the current quarter is entered, whereas, FIG. 8 shows the “Quarter Data Input” section where historically measured educational delivery data for six quarters (the preceding five quarters plus the current quarter) is entered. As shown in FIG. 7A, the “Description” column has many description headings, however, only the following are included for the actual measured educational delivery data: Number of Lab Rooms, Number of Lecture Rooms, Total Number of Lab Seats Available and Total Number of Lecture Seats Available. Here the classrooms are classified into lab and lecture rooms, however, the model can be customized to fit the needs of an educational venue, for instance, you could have art classrooms. Also, it is preferable to enter into the Input section, data for “the Site Population (regulars only)” and “Offsite Class Percentage”. In the example, the “Site Population” has an input of “1,070”, whereas, the “Offsite Class Percentage” has an input of “0.00%”. The “Offsite Class Percentage” provides an indication of whether there are other educational facilities in the area that can provide education. Here the “0.00%” input indicates that there are no other educational facilities in the area. The rest of the description headings, such as, “Total Classrooms”, “Total Number of Seats” are calculations that are automatically carried out by the Delivery Location Model and are shown italicized. The formulas for FIG. 7A and 8 of the Input section of the Work segment are shown in FIG. 7B, which shows the various calculations performed by the Delivery Location Model. Also, referring to FIG. 7A, next to the “Input” column (where data is entered), there are other columns, entitled, “Adjustment”, “Model Total”, “Why Adjusted?” and “Adjustment Detail”. The “Adjustment” column can be used if any one or more of the inputted data needs to be adjusted for any number of reasons. The “Model Total” column sums up the “Input” and “Adjustment” columns, whereas the user can enter explanations in the “Why Adjusted” column and details in the “Adjustment Detail” column.

In the example, the classes have been categorized as “Non-local Classes”, “Local Classes” and “$0 Classes”. This categorization of classes is based on the level of FTE effort involved in order to operate the class. “Non-local Classes” are those that are not operated or run by the local educational venue, but are simply scheduled at the educational venue or site. “Local Classes” are those that are operated and offered at the educational venue (that is, the FTEs make all the necessary arrangements to run each of these classes, such as contact vendor, schedule instructor, pay the vendor, etc.) whereas, “$0 Classes” are those that are operated and offered at the educational venue, but where there is no cost generated or minimal cost is generated, for instance, if someone at the educational facility teaches the class so that the educational facility does not have to pay that person. Again, the categorization can be based on a different factor.

The data entered into the Input section of FIG. 7A is also transferred into the Summary segment of the Delivery Location Model (as shown in FIG. 13), so that the user does not have to go to and from the Work segment to see what input data was used for calculating the results shown in the Summary segment. Similarly, as shown in FIG. 8, all but two of the description headings (that is, Site Population (regulars only) and Offsite Class Percentage) are repeated on the right side of the “Quarter Data Input” box. Preferably, the historically measured data includes: Number of Lab Rooms, Number of Lecture Rooms, Total Number of Lab Seats Available, Total Number of Lecture Seats Available, Lab Utilization Average, Lecture Utilization Average, Number of Non-local Classes, Number of Local Classes, Number of $0 classes, Number of Cancellations, Number of Non-local Student Days, Number of Local Student Days, Number of $0 Student Days and Total Number of Students. As can be seen from FIG. 8, some of the data has not been entered for the six quarters under the “Quarter Data Input” heading. When there is no data that has been entered (versus zero), the model auto corrects and calculates where there is data that has been entered. However, as long as data is provided for the rest of the items (that is, Lab Utilization Average, Lecture Utilization Average, Number of Non-local Classes, Number of Local Classes, Number of $0 classes, Number of Cancellations, Number of Non-local Student Days, Number of Local Student Days, Number of $0 Student Days and Total Number of Students), the model can still be utilized for managing and/or estimating educational delivery resources. Based on the data entered in the Input sections (shown in FIGS. 7A and 8) of the Work segment, the Delivery Location Model carries out calculations and displays the results both in the Work segment (FIG. 9A) as well as in the Summary segment of the Delivery Location Model (as shown in FIG. 11).

First, reference is made to the Summary segment of the Delivery Location Model, as shown in FIGS. 11, 12A and 13. The Summary segment is divided into a Results section (shown in FIG. 11), a Constants section (shown in FIG. 12A), and an Input section (shown in FIG. 13). The Input section shows data that is transferred from the Input section of the Work segment (as shown in FIG. 7A) for convenience to the user. Referring to the Constants section of FIG. 12A, this section lists the set of predetermined educational delivery data or model constants, and shows the values assigned to each corresponding data in the “Input” column. In particular, whenever, a user loads up a blank Delivery Location Model, the model contains this set of model constants or the set of predetermined educational delivery data. The inputted values for the model constants are based on certain assumptions that are based on knowledge and experience of operating an education delivery business, from accumulating historical data over a period of time and conducting historical analysis of the data. Again, a user can adjust, in the “Adjustment” column any one or more of these constants to achieve a particular result, but the user would have to preferably conduct a historical analysis of their data as well. Accordingly, the model is adaptable in that a particular result can be forecasted or achieved by making one or more knowledgeable adjustments to the various constants.

As shown in FIG. 12A, one constant or assumption that is utilized is a “classroom capacity” of 85%. Another constant employed in the model is a “classroom utilization” of 85%. Experience as far as running numerous educational centers has proven that 85% is considered a good average for variable length classes, that is, as long as most of the classes vary in the number of days it takes to run each of those classes. It is also assumed that the classes are run during normal business work days hours, that is, the first shift (9 a.m. to 5 p.m.) and no off hours (such as, weekends), or second or third shifts. Further, the model utilizes the assumptions that a FTE (a person working 40 hours a week per year) can arrange 30 Non-local classes per year and that a FTE can arrange 60 of the Local classes per year and a FTE can arrange 55 of the $0 classes per year. Similarly, based on previous experience, the constant of 15 is used for the number of FTE hours needed per class per year and the constant of 1925 is used for FTE hours available per year (that is, the number of hours that one FTE is available per year based on the standard forty hours per week for a year). Furthermore, it is assumed that on average there are 12 enrollments per class, regardless of the type of classrooms (that is, lecture or lab) and regardless of class types (Local, Non-local and $0 classes). Finally, the constant of 203 is used for the number of class days/classroom/year, that is, how many class days there are per room per year. The rest of the calculations are shown in FIG. 12B. The “Model Total” column reflects the numbers of quarters of historically measured educational data that is entered (in this example, six quarters), and the formulas are shown in FIG. 12B. Also, of significance, as shown in the “Input” column of FIG. 12A, are the constants assigned to “Non-local classes/FTE”, “Local classes/FTE” and “$0 classes/FTE”. In particular, based on historical data, it is assumed that an FTE can run 30 Non-local classes/year, 60 Local classes/year and 55 $0 classes/year. However, this assumption for the classes/FTE is balanced out by utilizing a “Model Weight” factor with respect to the level of effort involved in each of the different class types (that is, the Local classes, Non-local classes and $0 classes). As mentioned above, the class types (local, non-local and $0 classes) are categorized based on the level of effort of work done by people or FTEs. In particular, under the column of “Model Weight”, a model weight factor of 1 is assigned for Local classes, whereas, 0.75 is assigned for Non-local classes and 0.5 is assigned for $0 classes. For Local classes, the weight factor of 1 states that 100% of FTE effort is needed to run such classes. On the other hand, for Non-local classes, the weight factor of 0.75 states that 75% of FTE effort is needed to run Non-local classes and the weight factor of 0.5 states that 50% effort is needed to run $0 classes. Accordingly, the “Model Weight” factor is used in calculating data in the Results section of the Work segment (FIG. 9A), which is also displayed in the Summary segment (FIG. 11).

Next, referring to the Work segment (shown in FIG. 9A) of the Delivery Location Model, this section has the following headings of “Description”, “Have/Tactical”, “Base/Need (hours/class)”, “Need/Have Delta”, “Model Prediction” and “Weighted Prediction”. The results section shows the calculated educational resources needed to provide education based on the data entered into the Input section of the Delivery Location Model. In particular, the “Description” column lists the various educational delivery resources calculated by the Delivery Location Model, such as, “Tactical Headcount (FTE), “Classrooms”, “Classroom Capacity”, “Classroom Utilization”, “Average Enrollments/Class” and “Predictive Student Days”. In particular, the first two numbers in the “Have/Tactical” column correspond to data inputted, whereas the next two numbers are the constants assumed by the model. “Average Enrollments/Class” is calculated, as shown in the formulas in FIG. 9B. Further, formulas for the data calculated under both the “Base/Need (hours/class)” the “Model Prediction” and the “Weighted Prediction” is also shown in FIG. 9B.

In particular, the “Tactical Headcount (FTE) data calculated under the “Weighted Prediction” column utilizes the “Model Weight” factor assigned to different classes/FTE, as shown in FIG. 12A. Finally, the data in the “Need/Have Delta” column shows the difference between the “Have/Tactical” and the “Base/Need (hours/class)” columns. Formulas for each of the educational resources under the “Base/Need”, “Model Prediction” and “Weighted Prediction” columns are shown in FIG. 9B. The Base/Need calculation provides a foundational calculation based on two components, the Total Number of Classes, a measured number, multiplied by the FTE (Full Time Equivalent) Required Per Class, a computed component. The FTE Required Per Class is computed by dividing the Hours per Class, that is, how many hours of an FTEs time is required to complete work on a class from start to finish, by the Total Hours Available, that is, how many hours per year is one FTE available for work. The Base/Need calculation is a raw baseline number of FTEs required, without consideration of the type of class and effort each type requires. It is normally a high estimate. The Model Prediction calculation provides a predictive calculation based on the Total Number of Classes divided by the Total Classes Per FTE. Total Classes Per FTE is the sum of the types of classes one FTE could complete start to finish in one year. The Model Prediction calculation refines the FTEs required by defining the number of each type of class that one FTE could complete in a year. This provides a more accurate prediction as, typically, each type of class requires a different level of effort. This level of effort is reflected in the Total Classes Per FTE. This number of classes is a best case prediction. The Weighted Prediction calculation refines the Model Prediction by weighting the types of classes. The Total Classes Per FTE provides a best case estimate of the number of classes one FTE could complete in a year. The weighting factor provides a facility to adjust the balance of effort to more accurately reflect the challenges of the business. This number ranges from 0 to 1 and the lower the number, the less efficiency there is in completing that type of class. If the organization is very experienced with a type of class, a weighting of 1 is applied. The weighting is reduced for either inexperience or other challenges to completing a type of class, for example, working with an outside organization.

Turning to the Calculations section of the Work segment, shown in FIG. 10A, the Calculations are sub-divided into FTEs, Classrooms, Classes and Student Days. The calculations for the Total FTE (Actual) reflects quarterly input and the formulas for both the Total FTE (Actual) Tactical and Strategic are shown in FIG. 10B. Similarly, calculations for data relating to the Classrooms, Classes and Student Days is shown in FIG. 10B. The calculated data reflects both quarterly as well as data reflecting the number of quarters entered, namely, six quarters. The FTEs section tells you how many FTEs are doing Tactical work and how many are doing Strategic work for each quarter, based on the six quarters worth of data inputted. The Classrooms section gives an indication of what the “total possible number of seats” that the educational facility could offer per year or the total number of students that could be served if an educational center was to operate at full capacity, that is, taking into account the total number of seats, the number of days that were available (that is, classdays/room/year) and the classroom capacity average (85%). Again, this is based on the assumption (model constant) that a classroom capacity average of 85% is considered a 100% classroom capacity. Similarly, the number of classes/Tactical FTE and the number of classes/Strategic FTE give an indication of how many students can be served with the respective Tactical and Strategic FTEs. Further, the number of site population/Total FTE gives an indication of how many students in the site population can be served with the Total FTEs. Finally, the “total possible student days” takes into account the fact that a 100% classroom utilization percentage (CR Util Pct) is 85% and not 100% in the education business to give an indication of the total possible student days. The user can adjust any one of “total possible number of seats”, “number of classes/Tactical FTE” and “number of classes/Strategic FTE”, “number of population/Total FTE”, and “total possible student days” by entering appropriate adjustments in the “Adjustment” columns, as shown in FIG. 10A.

Finally, turning to the Charts segment of the Delivery Location Model, the Charts segment graphically summarizes (as shown in FIGS. 14A-14D) a plurality of the calculated educational resources shown in the Results section of both the Work (FIG. 9A) and Summary (FIG. 11) segments, as well as displays the data entered into the Input section (FIG. 8) of the Work segment in FIG. 15A of the Charts segment. Further, FIG. 16A displays the Results section data in a chart form. The data depicted in the Charts segment is mostly duplication of data presented in the Summary, Input and Results section of the Delivery Location Model.

The foregoing descriptions of specific embodiments of the present invention have been presented for the purpose of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for managing a plurality of educational resources needed to deliver education, said method comprising:
providing a computer model with a set of predetermined educational delivery data;
entering into said computer model a plurality of educational delivery data, said plurality of educational delivery data including a plurality of measured educational delivery data accumulated over a time period and a plurality of historically measured educational delivery data accumulated over a plurality of time periods; and
calculating with said provided set of predetermined educational delivery data and said entered plurality of educational delivery data said plurality of educational resources needed to deliver education.

2. A method according to claim 1, further comprising the step of:
adjusting one or more of said provided set of predetermined educational delivery data and said entered plurality of educational delivery data so as to forecast one or more of said plurality of educational resources needed to deliver education.

3. A method according to claim 1, wherein said plurality of educational resources is selected from the group consisting of: educational employee headcount, number of classrooms, classroom capacity, classroom utilization, enrollments per class or predictive number of student days.

4. A method according to claim 1, wherein said plurality of educational resources comprises at least one of: educational employee headcount, number of classrooms, classroom capacity, classroom utilization, enrollments per class and predictive number of student days.

5. A method according to claim 1, wherein said set of predetermined educational delivery data includes classroom capacity, classes per educational employee per year, educational employee hours needed per class, educational employee hours available per year, enrollments per class, classroom utilization and number of available classdays per classroom per year.

6. A method according to claim 1, wherein said plurality of measured educational delivery data includes number of classrooms, number of classroom seats, classroom utilization average, number of classes, number of student days, total number of students and offsite class percentage; and wherein said time period for said plurality of measured educational delivery data is preferably a quarter.

7. A method according to claim 1, wherein said plurality of historically measured educational delivery data includes classroom utilization average, number of classes, number of student days and total number of students; and wherein said plurality of time periods for said plurality of historically measured educational delivery data is preferably at least three preceding quarters.

8. A method according to claim 6, wherein said plurality of measured educational delivery data further includes existing educational employee headcount and site population; and wherein said plurality of time periods for said plurality of historically measured educational delivery data is preferably at least five preceding quarters.

9. A method according to claim 1, wherein said step of providing a computer model further comprises:
providing separate delivery location models for each one of a set of educational venues; and
providing a rollup model for incorporating said separate delivery location models for one or more of said set of educational venues and calculating said plurality of educational resources needed to deliver education at said one or more of said set of educational venues.

10. A method according to claim 9, further comprising:
loading said separate delivery location models for a subset of said set of educational venues; and
selecting from said separate delivery location models loaded for said subset of said educational venues particular educational venues to be included in said rollup model so as to evaluate said plurality of educational resources needed to deliver education at said particular educational venues.

11. A method for estimating one or more of a plurality of educational delivery resources needed to deliver education to at least one educational venue, said method comprising:
providing a plurality of measured educational delivery data, said plurality of measured educational delivery data including actual measured educational delivery data and estimated measured educational delivery data;
providing a plurality of historically measured educational delivery data, said plurality of historically measured educational delivery data including actual historically measured educational delivery data and estimated historically measured educational delivery data;
inputting said plurality of measured and historically measured educational delivery data into a delivery location model with a set of predetermined educational delivery data; and
executing said delivery location model so as to calculate one or more of said plurality of educational delivery resources needed to deliver education to said at least one educational venue.

12. A method according to claim 11, wherein said plurality of educational delivery resources is selected from the group consisting of: educational employee headcount, number of classrooms, classroom capacity, classroom utilization, enrollments per class or predictive number of student days.

13. A method according to claim 11, wherein said set of predetermined educational delivery data includes classroom capacity, classes per educational employee per year, educational employee hours needed per class, educational employee hours available per year, enrollments per class, classroom utilization and number of available classdays per classroom per year.

14. A method according to claim 11, wherein said measured educational delivery data is selected from the group consisting of: number of classrooms, number of classroom seats, classroom utilization average, number of classes, number of student days, total number of students, offsite class percentage, educational employee headcount or site population.

15. A method according to claim 11, wherein said plurality of historically measured educational delivery data includes classroom utilization average, number of classes, number of student days and total number of students; and wherein said plurality of time periods for said plurality of historically measured educational delivery data is preferably at least three preceding quarters.

16. A method according to claim 15, further comprising the step of:
analyzing said one or more of said plurality of educational delivery resources calculated by said delivery location model; and
adjusting one or more of said inputted plurality of educational delivery data and said predetermined educational delivery data so as to validate said one or more of said plurality of educational delivery resources needed to deliver education at said at least one educational venue.

17. Programmable media containing programmable software to manage educational delivery resources, said programmable software comprising the steps of:
accessing a set of predetermined educational delivery data;
receiving in a memory a plurality of educational delivery data; and
calculating from said set of predetermined educational delivery data and said plurality of educational delivery data an estimate of said educational delivery resources needed to deliver education.

18. A programmable media according to claim 17, wherein the step of receiving in a memory further includes the steps of providing a plurality of measured educational delivery data accumulated over a time period and providing a plurality of historically measured educational delivery data accumulated over a plurality of time periods.

19. A programmable media according to claim 17, wherein said programmable software calculates said estimate of said educational delivery resources needed to deliver education with an accuracy of at least eighty-five percent.

20. A programmable media according to claim 17, further comprising the steps of:
receiving in said memory a second plurality of educational delivery data; and
calculating from said set of predetermined educational delivery data and said second plurality of educational delivery data a second estimate of educational resources needed to deliver education.
